(19) United States
(12) Patent Application Publication
(10) Pub. No.: US 2023/0219449 A1
(43) Pub. Date: Jul. 13, 2023

(54) SERVER APPARATUS, SYSTEM, AND OPERATING METHOD

(71) Applicant: TOYOTA JIDOSHA KABUSHIKI KAISHA, Toyota-shi (JP)

(72) Inventor: Daigo KITTAKA, Yokohama-shi (JP)

(73) Assignee: TOYOTA JIDOSHA KABUSHIKI KAISHA, Toyota-shi (JP)

(21) Appl. No.: 18/152,318

(22) Filed: Jan. 10, 2023

(30) Foreign Application Priority Data
Jan. 11, 2022 (JP) 2022-002628

(51) Int. Cl. B60L 53/66; B60L 53/30

(52) U.S. Cl. CPC B60L 53/665; B60L 53/305; B60L 2240/70

(57) ABSTRACT

A server apparatus includes a communication interface and a controller configured to communicate using the communication interface. The controller is configured to receive, from a vehicle driven by electricity from a battery, operation information on operation of the vehicle, transmit, to the vehicle or a charging/discharging apparatus, information on a charging/discharging plan for charging the battery with predetermined electricity purchased by a community, the charging/discharging plan including a charging/discharging timing for the vehicle and a charging/discharging location within the community based on the operation information, and control the vehicle or the charging/discharging apparatus to execute the charging/discharging plan.

### CROSS-REFERENCE TO RELATED APPLICATION

This application claims priority to Japanese Patent Application No. 2022-002628, filed on Jan. 11, 2022, the entire contents of which are incorporated herein by reference.

### TECHNICAL FIELD

The present disclosure relates to a server apparatus, a system, and an operating method.

### BACKGROUND

The concept of a community Energy Management System (EMS) is being developed in communities managed by local governments, companies, and the like for management, as a whole, of the power generation by power generation facilities distributed throughout the community, the power supply from the power system of an electric company, and the power demand occurring within the community. Various technologies have been proposed to predict the electricity consumption amount in a community so that electricity matching the electricity demand in the community can be supplied. Power loads that consume electricity include not only the various facilities located within the community, but also battery electric vehicles (BEVs) that travel within the community. Patent Literature (PTL) 1 proposes technology for predicting the timing of charging, charging position, and the like of BEVs.

### CITATION LIST

### Patent Literature

PTL 1: JP 2014-42383 A

### SUMMARY

In a case in which an individual community purchases electricity from an electric company through an electricity purchase agreement, any excess or shortage in the purchased electricity results in inefficiencies, such as the payment of imbalance fees or the purchase of additional, more expensive electricity.

In view of the above, the present disclosure relates to a server apparatus and the like that enables efficient consumption of the electricity purchased by a community.

A server apparatus in the present disclosure includes:

a communication interface; and

a controller configured to communicate using the communication interface, wherein the controller is configured to receive, from a vehicle driven by electricity from a battery, operation information on operation of the vehicle, transmit, to the vehicle or a charging/discharging apparatus, information on a charging/discharging plan for charging the battery with predetermined electricity purchased by a community, the charging/discharging plan including a charging/discharging timing for the vehicle and a charging/discharging location within the community based on the operation information, and control the vehicle or the charging/discharging apparatus to execute the charging/discharging plan.

A system in the present disclosure includes a vehicle driven by electricity from a battery, a charging/discharging apparatus configured to charge/discharge the battery, and a server apparatus configured to communicate with the vehicle and the charging/discharging apparatus, wherein

the server apparatus is configured to receive operation information on operation of the vehicle from the vehicle and transmit information on a charging/discharging plan for charging the battery with predetermined electricity purchased by a community, the charging/discharging plan including a charging/discharging timing for the vehicle and a charging/discharging location within the community based on the operation information, and

the vehicle or the charging/discharging apparatus is configured to receive the information on the charging/discharging plan and execute the charging/discharging plan.

An operating method of a system in the present disclosure is an operating method of a system including a vehicle driven by electricity from a battery, a charging/discharging apparatus configured to charge/discharge the battery, and a server apparatus configured to communicate with the vehicle and the charging/discharging apparatus, the operating method including:

receiving, by the server apparatus, operation information on operation of the vehicle from the vehicle and transmitting information on a charging/discharging plan for charging the battery with predetermined electricity purchased by a community, the charging/discharging plan including a charging/discharging timing for the vehicle and a charging/discharging location within the community based on the operation information; and

receiving, by the vehicle or the charging/discharging apparatus, the information on the charging/discharging plan and executing the charging/discharging plan.

According to the server apparatus and the like in the present disclosure, the electricity purchased by a community can be consumed efficiently.

### BRIEF DESCRIPTION OF THE DRAWINGS

In the accompanying drawings:

FIG. 1 is a diagram illustrating an example configuration of an information processing system;

FIG. 2 is a diagram illustrating an example configuration of a server apparatus;

FIG. 3 is a diagram illustrating an example configuration of a vehicle;

FIG. 4 is a diagram illustrating an example configuration of a charging/discharging apparatus;

FIG. 5 is a sequence diagram illustrating an operation example of an information processing system;

FIG. 6A is a flowchart illustrating an operation example of a server apparatus; and

FIG. 6B is a flowchart illustrating an operation example of a server apparatus.

### DETAILED DESCRIPTION

Embodiments are described below.

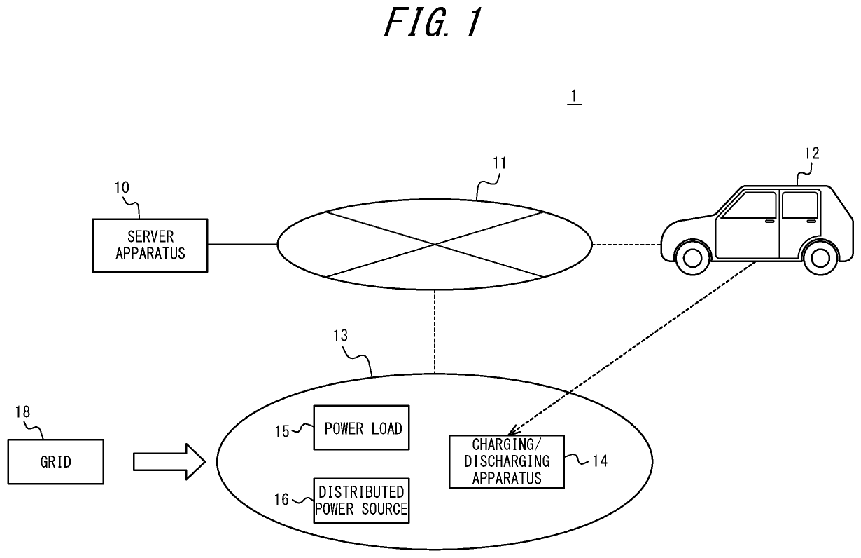

FIG. 1 is a diagram illustrating a configuration example of an information processing system according to an embodiment. The information processing system 1 is a system for supporting the efficient consumption of electricity purchased by a community from an electric company. As used below, a community is any town or regional unit managed by a municipality, company, or the like. The information processing system 1 includes one or more each of a server apparatus 10, a vehicle 12 driven by electricity from a battery, and an energy resource 13 within a community, which are communicably connected to each other via a network 11, for example. Energy resources 13 include charging/discharging apparatuses 14 for charging/discharging electricity to/from the vehicles 12, and power loads 15 and distributed power sources 16 distributed throughout the community. The electricity consumed by the energy resources 13 is supplied by a grid 18 or is provided by the distributed power sources 16.

The server apparatus 10 is, for example, a server computer that belongs to a cloud computing system or other computing system and operates as a community EMS (CEMS) server and a vehicle information server that manages information on the vehicle 12. The vehicle 12 is a passenger car, a multipurpose vehicle, or the like equipped with control and communication functions and driven by battery power, such as a BEV, a hybrid electric vehicle (HEV), or a plug-in hybrid electric vehicle (PHEV). The network 11 is, for example, the Internet, but may include an ad hoc network, a LAN, a metropolitan area network (MAN), or other networks, or any combination thereof. The charging/discharging apparatus 14 is a charging/discharging station installed in a community, includes a charging/discharging stand to which the vehicle 12 electrically connects, and is configured to communicate with the server apparatus 10 via the network 11. The power load 15 is an electric appliance, lighting, air conditioner, or the like installed in a residence, commercial facility, or the like, excluding the vehicle 12. The distributed power sources 16 include solar, wind, and other alternative energy-based generation devices; fuel cells; storage batteries; and the like. The operation of the power loads 15 and distributed power sources 16 is managed or controlled by power conditioners, smart meters, and the like that are connected to the network 11 and are configured to communicate information. Information on the operation of the power loads 15 and distributed power sources 16 is transmitted and received to and from the server apparatus 10 via the network 11 by the power conditioners, smart meters, and the like.

In the present embodiment, the server apparatus 10 receives, from a vehicle 12 driven by electricity from a battery, operation information on operation of the vehicle 12, transmits, to the vehicle 12 or a charging/discharging apparatus 14, information on a charging/discharging plan for charging the battery with predetermined electricity purchased by a community, the charging/discharging plan including a charging/discharging timing for the vehicle 12 and a charging/discharging location within the community based on the operation information, and controls the vehicle 12 or the charging/discharging apparatus 14 to execute the charging/discharging plan. The charging/discharging location is the position of the charging/discharging apparatus 14. This configuration enables more efficient consumption of the electricity purchased by the community.

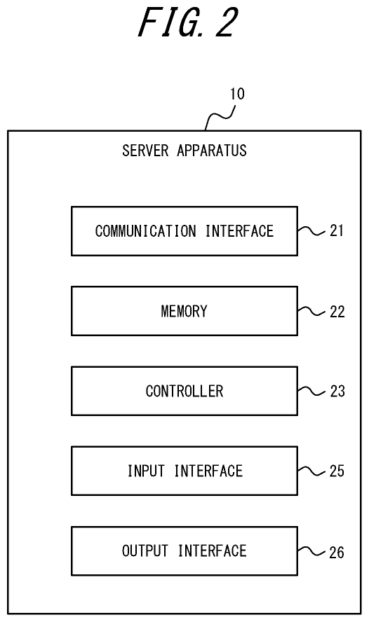

FIG. 2 illustrates an example configuration of the server apparatus 10. The server apparatus 10 includes a communication interface 21, a memory 22, a controller 23, an input interface 25, and an output interface 26. The server apparatus 10 is, for example, a single computer. The server apparatus 10 may be two or more computers that are communicably connected to each other and operate in cooperation. In this case, the configuration illustrated in FIG. 2 can be arranged among two or more computers as appropriate.

The communication interface 21 includes one or more interfaces for communication. The interface for communication is, for example, a LAN interface. The communication interface 21 receives information to be used for the operations of the server apparatus 10 and transmits information obtained by the operations of the server apparatus 10. The server apparatus 10 is connected to the network 11 by the communication interface 21 and communicates information with the vehicle 12 or the charging/discharging apparatus 14 via the network 11.

The memory 22 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 22 stores information to be used for the operations of the server apparatus 10 and information obtained by the operations of the server apparatus 10.

The controller 23 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 23 executes information processing related to operations of the server apparatus 10 while controlling components of the server apparatus 10.

The input interface 25 includes one or more interfaces for input. The interface for input is, for example, a physical key, a capacitive key, a pointing device, a touch screen integrally provided with a display, or a microphone that receives audio input. The input interface 25 accepts operations to input information used for operation of the server apparatus 10 and transmits the inputted information to the controller 23.

The output interface 26 includes one or more interfaces for output. The interface for output is, for example, a display or a speaker. The display is, for example, a liquid crystal display (LCD) or an organic electro-luminescent (EL) display. The output interface 26 outputs information obtained by the operations of the server apparatus 10.

The functions of the server apparatus 10 are realized by a processor included in the controller 23 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 23. The control program may be stored on a non-transitory recording/storage medium readable by the server apparatus 10 and be read from the medium by the server apparatus 10.

In the present embodiment, the memory 22 stores in advance information such as map information for an area including the community, the position of the charging/discharging apparatus 14 in the community, and the like.

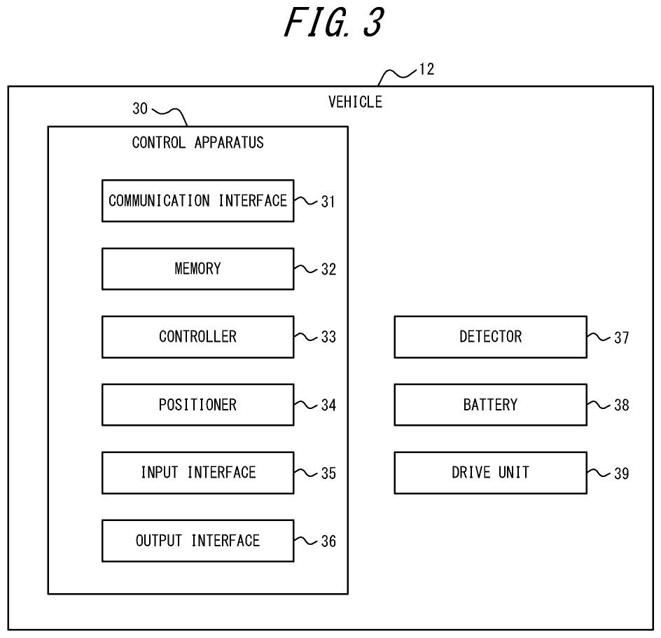

FIG. 3 illustrates a configuration example of the vehicle 12. The vehicle 12 includes a battery 38 and a drive unit 39 driven by electricity from the battery 38, and the vehicle 12 travels by operation of the drive unit 39. The battery 38 is, for example, a lithium-ion battery. The drive unit 39 includes a motor for driving the drive wheels, braking mechanism, and other such components; a control circuit for the motor; and the like. The vehicle 12 further includes a control apparatus 30 and a detector 37. The control apparatus 30 includes a communication interface 31, a memory 32, a controller 33, a positioner 34, an input interface 35, and an output interface 36. The control apparatus 30 includes an electronic control unit (ECU), for example. The control apparatus 30 may be configured by two or more apparatuses, including a communication device. The communication device includes a data communication module (DCM), for example. The control apparatus 30 may be configured to include a personal computer, a tablet terminal, a smartphone terminal, a navigation apparatus, or the like. The detector 37 includes sensors that detect the level of the battery 38 and the temperature, current value, and the like of the motor in the drive unit 39. The components are communicably connected to each other, or to other devices and apparatuses in the vehicle 12, by an in-vehicle network compliant with standards such as a controller area network (CAN).

Details on each component of the control apparatus 30 are as follows.

The communication interface 31 includes one or more interfaces for communication. Examples of the interface for communication include an interface corresponding to mobile communication standards, such as Long Term Evolution (LTE), 4th Generation (4G), or 5th Generation (5G). The communication interface 31 receives information to be used for the operations of the controller 33 and transmits information obtained by the operations of the controller 33. The controller 33 connects to the network 11 using the communication interface 31 through a mobile communication base station and communicates information with other apparatuses via the network 11.

The memory 32 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information to be used for the operations of the controller 33 and information obtained by the operations of the control apparatus 30.

The controller 33 includes one or more processors, one or more dedicated circuits, or a combination thereof. Examples of the processor include a general purpose processor such as a CPU and a dedicated processor dedicated to specific processing. The dedicated circuit is, for example, an FPGA or an ASIC. The controller 33 executes information processing pertaining to operations of the vehicle 12.

The positioner 34 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioner 34 acquires the positional information for the vehicle 12 and transmits the positional information to the controller 33.

The input interface 35 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 35 accepts user operations to input information used for operation of the controller 33 and transmits the inputted information to the controller 33.

The output interface 36 includes one or more interfaces for output. The interface for output is, for example, a display or a speaker. The display is, for example, an LCD or an organic EL display. The output interface 36 outputs the information obtained by the operation of controller 33 to the user or driver, for example.

The functions of the controller 33 are realized by a processor included in the controller 33 executing a control program. The control program is a program for causing a computer to execute the processing of steps included in operations of the controller 33, thereby enabling the computer to realize the functions corresponding to the processing of the steps. That is, the control program is a program for causing a computer to function as the controller 33. Some or all of the functions of the controller 33 may be realized by a dedicated circuit included in the controller 33.

The controller 33 stores operation information on operation of the vehicle 12 in the memory 32. The operation information includes information such as the date, positional information and time, time of connection to a charging stand, battery level, history of electricity consumption amount and the like, and guidance routes set in the navigation system. The history is, for example, recorded in appropriate cycles from several seconds to several hours. The controller 33 also stores driver personal information in the memory 32. The driver personal information includes information such as a name and address to identify the driver. The controller 33 accepts the driver personal information that is inputted once by the driver using the input interface 35 and stores the driver personal information in the memory 32.

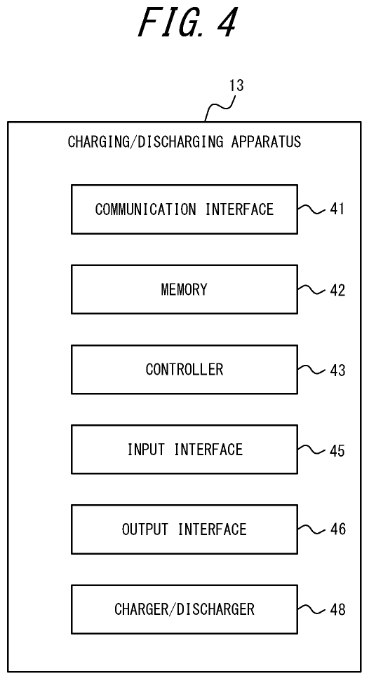

FIG. 4 is a diagram illustrating a configuration of the charging/discharging apparatus 14. The charging/discharging apparatus 14 includes a communication interface 41, a memory 42, a controller 43, and a charger/discharger 48.

The communication interface 41 includes a communication module compliant with a wired or wireless LAN standard, a module compliant with a mobile communication standard such as LTE, 4G, or 5G, or the like. The charging/discharging apparatus 14 connects to the network 11 via a nearby router apparatus or mobile communication base station using the communication interface 41 and communicates information with the server apparatus 10 and the like over the network 11.

The memory 42 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores information to be used for the operations of the controller 43 and information obtained by the operations of the controller 43.

The controller 43 has one or more general purpose processors such as CPUs or micro processing units (MPUs) or one or more dedicated processors that are dedicated to specific processing. Alternatively, the controller 43 may have one or more dedicated circuits such as FPGAs or ASICs. The controller 43 is configured to perform overall control of the operations of the charging/discharging apparatus 14 by operating according to the control/processing programs or operating according to operation procedures implemented in the form of circuits. The controller 43 then transmits and receives various types of information to and from the server apparatus 10 and the like via the communication interface 41 and executes the operations according to the present embodiment.

The input interface 45 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 45 accepts operations for inputting information to be used in the operations of the controller 43 and transmits the inputted information to the controller 43.

The output interface 46 includes one or more interfaces for output. The interface for output is, for example, a display or a speaker. The display is, for example, an LCD or an organic EL display. The output interface 46 outputs information obtained by the operations of the controller 43.

The functions of the controller 43 are realized by a processor included in the controller 43 executing a control program. The control program is a program for causing the processor to function as the controller 43. Some or all of the functions of the controller 43 may be realized by a dedicated circuit included in the controller 43.

The charger/discharger 48 includes a charging/discharging station that has a connector and feeder cable that connect to an inlet of the vehicle 12, a switch for opening and closing the connection of the power line to the power load 15 of the energy resource 13 or to the grid 18, a battery or capacitor for storing electricity, and the like. The charger/discharger 48 can switch the switch, in response to an instruction from the controller 43, to charge the battery 38 of the vehicle 12 with electricity supplied from the grid 18 or to supply electricity discharged from the battery 38 of the vehicle 12 to the power load 15 of the energy resource 13 or to the grid 18.

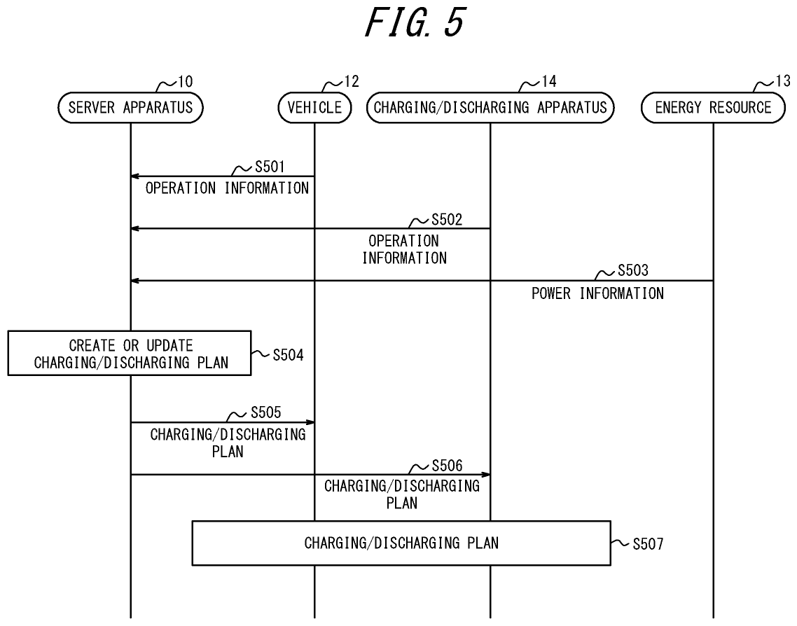

FIG. 5 is a sequence diagram illustrating an operation example of the information processing system 1. FIG. 5 illustrates the procedures for coordinated operation by the server apparatus 10, the vehicle 12, the charging/discharging apparatus 14, and the energy resources 13 other than the charging/discharging apparatus 14. In FIG. 5, the various power loads 15 and distributed power sources 16 are treated collectively. The transmission and reception of information by the energy resources 13 in FIG. 5 is performed by power conditioners, smart meters, and the like that manage or control the various power loads 15 and distributed power sources 16. In FIG. 5, the steps pertaining to the various information processing by the server apparatus 10, the vehicle 12, and the charging/discharging apparatus 14 are performed by the respective controllers 23, 33, 43. The steps pertaining to transmitting and receiving various types of information to and from the server apparatus 10, the vehicle 12, and the charging/discharging apparatus 14 are performed by the respective controllers 23, 33, 43 transmitting and receiving information to and from each other via the respective communication interfaces 21, 31, 41. In the server apparatus 10, the vehicle 12, and the charging/discharging apparatus 14, the respective controllers 23, 33, 43 appropriately store the information that is transmitted and received in the respective memories 22, 32, 42. Furthermore, the respective controllers 33, 43 of the vehicle 12 and the charging/discharging apparatus 14 accept input of various information by the input interfaces 35, 45 and output various information by the output interfaces 36, 46.

The procedures in FIG. 5 are, for example, performed at any time before the start of the electricity purchase market each day.

In step S500, the vehicle 12 transmits operation information to the server apparatus 10. The operation information includes the date, positional information and time, time of connection to a charging stand, battery level, history of electricity consumption amount and the like, guidance routes, and driver personal information. The operation information is, for example, transmitted to the server apparatus at any appropriate time before the start of the electricity purchase market each day.

In step S502, the charging/discharging apparatus 14 transmits power information to the server apparatus 10. The power information is the history of the electricity consumption amount and the electricity supply amount by the charging/discharging apparatus 14 over the previous one to several days, for example. The electricity consumption amount is the electricity supplied from the grid 18 and consumed to charge the vehicle 12. The electricity supply amount is the electricity supplied to the energy resource 13 by discharging the battery 38 of the vehicle 12.

In step S503, the energy resource 13 transmits the power information to the server apparatus 10. The power information is the history of the electricity consumption amount by the power load 15 and the electricity supply amount by the distributed power source 16 over the previous one to several days, for example. The electricity consumption amount is the electricity supplied from the grid 18 and consumed by the power load 15. The electricity supply amount is the electricity that is generated by a power generation apparatus, or discharged from a storage battery, included in the distributed power source 16 and is supplied to the energy resource 13.

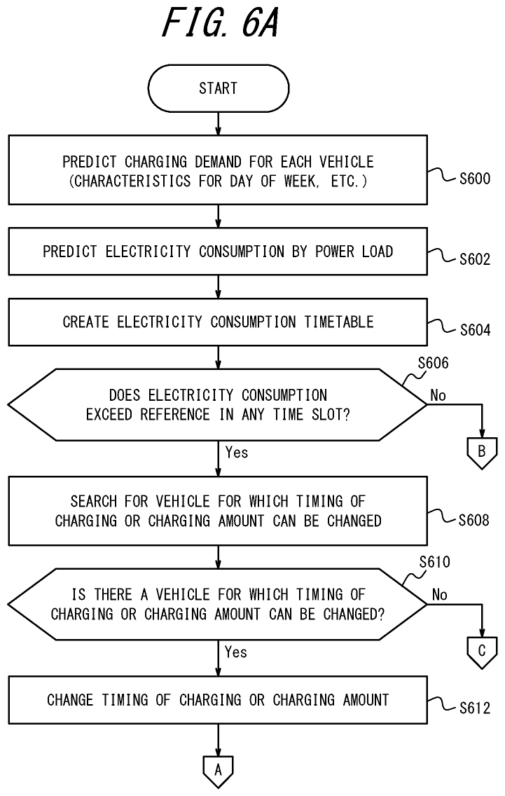

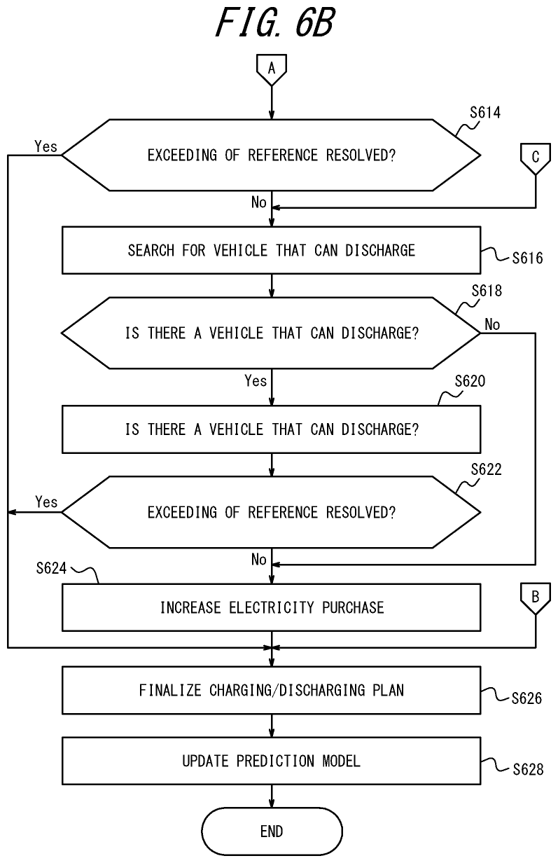

In step S504, the server apparatus 10 creates or updates a charging/discharging plan for the vehicle 12 and the charging/discharging apparatus 14 using the information received from the vehicle 12, the charging/discharging apparatus 14, and the energy resource 13. The detailed procedures of step S504 are explained here using FIGS. 6A and 6B.

FIGS. 6A and 6B are flowcharts illustrating the operating procedures by the controller 23 of the server apparatus 10 for creating or updating the charging/discharging plan.

In step S600 of FIG. 6A, the controller 23 predicts the charging demand for each vehicle 12. The charging demand includes the charging amount, timing of charging, and charging location for each vehicle 12. The controller 23 uses any appropriate algorithm to predict the charging amount and timing of charging for each vehicle 12 based on the operation information. For example, the controller 23 predicts a travel route based on the history of positional information or the guidance route included in the operation information. During the prediction, the controller 23 may take into account characteristics related to the day of the week. The travel route is, for example, a route for commuting to work or school, a route traveled on business, or the like. The controller 23 derives the electricity consumption per unit distance from the distance of past travel routes and the change in battery level and uses the results to predict the change in battery level based on the distance of the predicted travel route and the most recent battery level. Furthermore, the controller 23 derives the battery level at which the driver determines that charging is necessary (referred to for convenience as the level requiring charging) from the past connection time to the charging stand and the battery level at that time. Furthermore, the controller 23 predicts the time when the most recent battery level will reach the level requiring charging as the timing of charging and derives the charging amount for reaching a fully charged state from the level requiring charging. The controller 23 then derives the location of a charging/discharging apparatus 14 that can be re ached from the predicted travel route by the timing of charging as the charging location. Alternatively, the controller 23 may predict the optimal charging amount, the timing of charging, and the charging location using a prediction model obtained by performing machine learning using the operation information on the vehicle 12 and power information on the charging/discharging apparatus 14 as training data.

In step S602, the controller 23 predicts the electricity consumption by the power load 15. The prediction of electricity consumption includes, for example, the electricity consumption amount in each time slot of one to several hours. The controller 23 predicts the electricity consumption based on power information from the energy resource 13 using any appropriate algorithm. For example, the controller 23 predicts the electricity consumption by taking into account characteristics related to the day of the week within the past change in the electricity consumption amount. The electricity consumption by the power load 15 is, for example, electricity that cannot be covered by the electricity from the distributed power source 16 but rather is received from the grid 18 and consumed. Alternatively, the controller 23 may predict the electricity consumption by the power load 15 using a prediction model obtained by performing machine learning using the power information from the energy resource 13 as training data.

In step S604, the controller 23 creates an electricity consumption timetable. The controller 23 sums up the charging amount in the charging demand for one or more vehicles 12 and the electricity consumption amount by the power load 15 for each time slot to create an electricity consumption amount timetable for the community as a whole.

In step S606, the controller 23 determines whether there is a time slot in the electricity consumption timetable during which the electricity consumption amount exceeds a reference. The reference is the electricity that can be consumed in each time slot and is calculated by, for example, dividing the electricity scheduled to be purchased among the time slots. In a case in which the reference is not exceeded in any time slot (No in step S606), the controller 23 proceeds to step S626 of FIG. 6B. Conversely, in a case in which the reference is exceeded in any time slot (Yes in step S606), the controller 23 proceeds to step S608.

In step S608, the controller 23 searches for a vehicle 12, among the charging demands of the vehicles 12, for which the timing of charging or the charging amount can be changed. For example, the controller 23 simulates the change in battery level for each vehicle 12 in the case of moving the timing of charging forward or backward, determines that the timing of charging can be changed in a case in which the battery level after charging enables travel on the subsequent travel route, and determines that the timing of charging cannot be changed in a case in which the battery level does not enable travel. Here, the travel route for which the possibility of travel is determined includes, for example, the route to another charging/discharging apparatus 14 in addition to the predicted travel route. The controller 23 also simulates the change in battery level for each vehicle 12 in the case of changing the charging amount, determines that the charging amount can be changed in a case in which the changed charging amount enables travel on the subsequent travel route, and determines that the charging amount cannot be changed in a case in which the changed charging amount does not enable travel.

In a case of there being no vehicle 12 for which the timing of charging or the charging amount can be changed (No in step S610), the controller 23 proceeds to step S616 in FIG. 6B. Conversely, in a case of there being a vehicle 12 for which the timing of charging or the charging amount can be changed (Yes in step S610), the controller 23 proceeds to step S612.

In step S612, the controller 23 changes the timing of charging or the charging amount for the vehicle 12 for which the timing of charging or the charging amount can be changed.

In step S614 of FIG. 6B, the controller 23 determines whether the electricity consumption amount no longer exceeds the reference in the electricity consumption timetable after the timing of charging or the charging amount of the vehicle 12 is changed. In a case in which the reference is no longer exceeded (Yes in step S614), the controller 23 proceeds to step S626. Conversely, in a case in which the reference is still exceeded (No in step S614), the controller 23 proceeds to step S616.

In step S616, the controller 23 searches for a vehicle 12, among the vehicles 12, that can be discharged. For example, the controller 23 simulates the change in the battery level in a case in which the battery 38 is discharged for each vehicle 12 during the time slot in which the electricity consumption amount exceeds the reference. At this time, the controller 23 runs the simulation using any appropriate number of discharge amounts. The controller 23 determines that the vehicle 12 can be discharged in a case in which the battery level after discharge enables the vehicle 12 to travel the subsequent travel route or to travel and then charge during another time slot, and that the vehicle cannot be discharged otherwise. For example, the controller 23 may be configured to ensure the battery level necessary for traveling the predicted travel route while shifting the peak by using the remaining capacity of the battery 38 to temporarily charge the battery 38 and then discharging the battery 38 during peak electricity consumption for the community as a whole.

In a case in which no vehicle 12 can be discharged (No in step S618), the controller 23 proceeds to step S624. Conversely, in a case in which there is a vehicle 12 that can be discharged (Yes in step S618), the controller 23 proceeds to step S620.

In step S620, the controller 23 incorporates the schedule to discharge the vehicle 12 capable of discharging into the electricity consumption timetable.

In step S622, the controller 23 determines whether the electricity consumption amount no longer exceeds the reference in the electricity consumption timetable after incorporation of the schedule to discharge the vehicle 12. In a case in which the reference is still exceeded (No in step S622), the controller 23 proceeds to step S624. Conversely, in a case in which the reference is no longer exceeded (Yes in step S622), the controller 23 proceeds to step S626.

In step S624, the controller 23 performs a process to increase the electricity purchase. This is a case in which the reference is exceeded in the electricity consumption timetable, and even if the timing of charging or the charging amount is changed and/or a discharge schedule is incorporated, the reference is still exceeded. The controller 23 therefore performs a process to increase the amount of electricity to purchase so as to cover the excess. With this configuration, electricity can be purchased at a lower cost than in a case in which electricity is additionally purchased after the electricity purchase market has closed.

In step S626, the controller 23 finalizes a charging/discharging plan for each vehicle 12 based on the electricity consumption timetable. The charging/discharging plan for the vehicle 12, i.e., the charging/discharging timing, charging/discharging amount, and charging/discharging location, is finalized in a case in which the reference is not exceeded in the original electricity consumption timetable, in a case in which the reference is exceeded, and therefore one or more measures are taken, such as changing the timing of charging or the charging amount and/or incorporating a discharge schedule, so that the reference is no longer exceeded, or in a case in which the reference is still exceeded, and the electricity purchase is increased.

In step S628, the controller 23 updates the prediction model for predicting the charging demand of the vehicle 12 using the finalized charging/discharging plan. This configuration can improve the prediction accuracy.

Returning to FIG. 5, in step S505, the server apparatus 10 transmits information on the charging/discharging plan to the vehicle 12. The charging/discharging plan includes information on the charging/discharging timing, the charging/discharging amount, and the charging/discharging location. The vehicle 12 presents information on the charging/discharging plan to the driver to encourage the driver to execute the charging/discharging plan. The vehicle 12 may incorporate the charging/discharging timing and charging/discharging location into the guidance route and provide route guidance to the driver.

In step S506, the server apparatus 10 transmits information on the charging/discharging plan to the charging/discharging apparatus 14 designated at the charging/discharging location in the charging/discharging plan. In a case in which the charging/discharging location is a parking lot or the like, and the charging/discharging timing occurs during parking, the server apparatus 10 transmits the charging/discharging plan to the charging/discharging apparatus 14 installed in the parking lot and controls the charging/discharging apparatus 14 to perform charging/discharging according to the charging/discharging plan.

In step S507, the vehicle 12 and the charging/discharging apparatus 14 perform charging/discharging of the vehicle 12. Step S507 may be performed before or after the end of the electricity purchase market. For example, upon the driver moving the vehicle 12 to the designated charging/discharging location and connecting the vehicle 12 to the charging/discharging apparatus 14 at the charging/discharging timing, the vehicle 12 and the charging/discharging apparatus 14 perform charging or discharging of the vehicle 12. The charging/discharging apparatus 14 may notify the driver of the arrival of the charging/discharging timing by outputting an image or sound. Alternatively, in a case in which the charging/discharging timing arrives while the vehicle 12 is parked in a parking lot or the like, the driver leaves the vehicle 12 parked while connected to the charging/discharging apparatus 14, and the vehicle 12 and the charging/discharging apparatus 14 perform charging/discharging when the charging/discharging timing is reached.

The information processing system 1 can perform the procedures in FIGS. 5, 6A, and 6B any number of times before the electricity purchase market closes, for example. Even when the vehicle 12 has started moving and is in movement, the server apparatus 10 can acquire the operation information for the vehicle 12 as needed and update the prediction of the charging demand, making it possible to update the charging/discharging plan in accordance with the actual electricity consumption by the vehicle 12. The vehicle 12 can be charged and discharged multiple times a day, for example. In this way, the electricity consumption amount and timing of electricity consumption for charging the vehicle 12 can be equalized to avoid a situation in which the electricity consumption exceeds the electricity purchased from the grid 18 in the community as a whole. This achieves more efficient consumption.

The server apparatus 10 may also create not only a charging/discharging plan for the current day for the vehicle 12 but also a charging/discharging plan for the next day and beyond and transmit the method in the charging/discharging plan to the vehicle 12 and the charging/discharging apparatus 14.

The server apparatus 10 may also acquire information on the electricity supply capacity of the distributed power source 16 as the power information from the energy resource 13 and transmit an instruction to the distributed power source 16 to supply electricity in a case in which the peak electricity consumption of the community as a whole cannot be resolved by recharging/discharging of the vehicles 12 alone.

In the above embodiment, a processing/control program that specifies operations of the controller 33 of the vehicle 12 and the controller 43 of the charging/discharging apparatus 14 may be stored in the memory 22 of the server apparatus 10 or in the memory of another server apparatus and be downloaded onto each apparatus via the network 11. The processing/control program may also be stored on a non-transitory recording/storage medium readable by each apparatus, and each apparatus may read the program from the medium.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface; and
a controller configured to communicate using the communication interface, wherein the controller is configured to receive, from a vehicle driven by electricity from a battery, operation information on operation of the vehicle, transmit, to the vehicle or a charging/discharging apparatus, information on a charging/discharging plan for charging the battery with predetermined electricity purchased by a community, the charging/discharging plan including a charging/discharging timing for the vehicle and a charging/discharging location within the community based on the operation information, and control the vehicle or the charging/discharging apparatus to execute the charging/discharging plan.

2. The server apparatus according to claim 1, wherein the operation information includes information on a battery level of the vehicle and information on a travel route.

3. The server apparatus according to claim 2, wherein the information on the travel route includes a guidance route and a history of the travel route.

4. The server apparatus according to claim 1, wherein the controller is configured to create the charging/discharging plan taking into account a consumption of the predetermined electricity by a power load within the community.

5. A system comprising a vehicle driven by electricity from a battery, a charging/discharging apparatus configured to charge/discharge the battery, and a server apparatus configured to communicate with the vehicle and the charging/discharging apparatus, wherein
the server apparatus is configured to receive operation information on operation of the vehicle from the vehicle and transmit information on a charging/discharging plan for charging the battery with predetermined electricity purchased by a community, the charging/discharging plan including a charging/discharging timing for the vehicle and a charging/discharging location within the community based on the operation information, and
the vehicle or the charging/discharging apparatus is configured to receive the information on the charging/discharging plan and execute the charging/discharging plan.

6. The system according to claim 5, wherein the operation information includes information on a battery level of the vehicle and information on a travel route.

7. The system according to claim 6, wherein the information on the travel route includes a guidance route and a history of the travel route.

8. The system according to claim 5, wherein the server apparatus is configured to create the charging/discharging plan taking into account a consumption of the predetermined electricity by a power load within the community.

9. An operating method of a system comprising a vehicle driven by electricity from a battery, a charging/discharging apparatus configured to charge/discharge the battery, and a server apparatus configured to communicate with the vehicle and the charging/discharging apparatus, the operating method comprising:
receiving, by the server apparatus, operation information on operation of the vehicle from the vehicle and transmitting information on a charging/discharging plan for charging the battery with predetermined electricity purchased by a community, the charging/discharging plan including a charging/discharging timing for the vehicle and a charging/discharging location within the community based on the operation information; and
receiving, by the vehicle or the charging/discharging apparatus, the information on the charging/discharging plan and executing the charging/discharging plan.

10. The operating method according to claim 9, wherein the operation information includes information on a battery level of the vehicle and information on a travel route.

11. The operating method according to claim 10, wherein the information on the travel route includes a guidance route and a history of the travel route.

12. The operating method according to claim 9, wherein the server apparatus creates the charging/discharging plan taking into account a consumption of the predetermined electricity by a power load within the community.
